(19) United States
(12) Patent Application Publication
(10) Pub. No.: US 2021/0140660 A1
(43) Pub. Date: May 13, 2021

(54) SETTING VALUE CALCULATION SYSTEM, METHOD, AND PROGRAM

(71) Applicant: NEC Corporation, Minato-ku, Tokyo (JP)

(72) Inventor: Takuma KOGO, Tokyo (JP)

(73) Assignee: NEC Corporation, Minato-ku, Tokyo (JP)

(21) Appl. No.: 16/612,016

(22) PCT Filed: May 15, 2017
(86) PCT No.: PCT/JP2017/018199

§ 371 Date: Nov. 8, 2019

(51) Int. Cl. F24F 11/30; F24F 11/63; G06F 30/20

(52) U.S. Cl. CPC F24F 11/30; F24F 2110/10; G06F 30/20; F24F 11/63

(57) ABSTRACT

For one or more parameters of a plurality of parameters to be used for calculation of a comfort index, the comfort-index parameter range determination unit 15 determines the range of possible values of each of the one or more parameters. The comfort index model generation unit 16 approximates the comfort index on the basis of a value within the range determined for each of the one or more parameters, to generate a mathematical model of the comfort index. The setting value calculation unit 17 calculates, with the comfort index, setting values of one or more setting items for one or more air conditioners on the basis of the mathematical model.

### TECHNICAL FIELD

The present invention relates to a setting value calculation system that calculates setting values for air conditioners, a setting value calculation method, and a setting value calculation program.

### BACKGROUND ART

PTL 1 proposes a method of operating air conditioners with maximization in energy efficiency, in consideration of the comfort in air-conditioned space.

PTL 1 describes a method of planning setting values for air conditioners by combination of a mathematical model representing the thermal characteristics of air-conditioned space and a mathematical model representing the power characteristics of the air conditioners. Specifically, according to the method described in PTL 1, a combination of setting values for the air conditioners is calculated so that the air conditioning power is minimized with a preset indoor temperature upper-and-lower limit range as a constraint condition.

In addition, PTL 2 describes that comfort optimization is formulated with simplification of a conditional expression in predicted mean vote (PMV) calculation.

Note that PMV is also referred to as predicted mean thermal sensation vote. PMV is one of the comfort indices to express how people feel hot and cold.

Moreover, NPL 1 describes that PMV is calculated with parameters such as temperature and radiation temperature.

### CITATION LIST

### Patent Literature

PTL 1: Japanese Patent No. 5951120
PTL 2: Japanese Patent Application Laid-Open No. 2014-231983

### Non Patent Literature

NPL 1: Jiri Cigler et. al., “Optimization of Predicted Mean Vote Thermal Comfort Index within Model Predictive Control Framework”, IEEE Conference on Decision and Control, pp. 3056-3061, 2012

### SUMMARY OF INVENTION

### Technical Problem

In the technique described in PTL 1, it has been difficult to use an upper-and-lower limit range regarding a comfort index, instead of the indoor temperature upper-and-lower limit range. This is because a comfort index represented by PMV generally has characteristics such as nonlinearity, nonconvexity, or a non-differentiable point in parameters (e.g., temperature and humidity) for calculating the comfort index and handling in calculation is extremely difficult when the plan of the setting values for the air conditioners are calculated.

In order to avoid this difficulty, a simple comfort index has been used by limiting the comfort index to temperature or humidity in some cases. For example, according to the technique described in PTL 1, a comfort temperature range is set. However, when a simple comfort index is used in such a manner, the other parameters are not considered, and a gap occurs between the comfort index and the actual comfort. For example, as in the technique described in PTL 1, when the comfort temperature range is used as the comfort index, the other parameters such as humidity are not considered. Thus, there may be a case where the temperature is not comfort even within the comfort temperature range that is set. That is, there may be a case where the setting values for the air conditioners are calculated on the basis of an inaccurate comfort index.

Therefore, an objective of the present invention is to provide a setting value calculation system, a setting value calculation method, and a setting value calculation program that enable easy and accurate calculation of a value of a comfort index, and enable, with the value of the comfort index, calculation of setting values for air conditioners.

### Solution to Problem

A setting value calculation system according to the present invention is a setting value calculation system that calculates setting values for one or more air conditioners installed in a building, the setting value calculation system including: a comfort-index parameter range determination unit that determines, for one or more parameters of a plurality of parameters to be used for calculation of a comfort index, a range of possible values of each of the one or more parameters; a comfort index model generation unit that approximates the comfort index, on the basis of the values within the range determined for each of the one or more parameters, to generate a mathematical model of the comfort index; and a setting value calculation unit that calculates, with the comfort index, setting values of one or more setting items for the one or more air conditioners on the basis of the mathematical model.

In addition, a setting value calculation method according to the present invention is a setting value calculation method of calculating setting values for one or more air conditioners installed in a building, the setting value calculation method including: determining, for one or more parameters of a plurality of parameters to be used for calculation of a comfort index, a range of possible values of each of the one or more parameters; approximating the comfort index, on the basis of the values within the range determined for each of the one or more parameters, to generate a mathematical model of the comfort index; and calculating, with the comfort index, on the basis of the mathematical model, setting values of one or more setting items for the one or more air conditioners.

Moreover, a setting value calculation program according to the present invention is a setting value calculation program installed on a computer that calculates setting values for one or more air conditioners installed in a building, the setting value calculation program for causing the computer to execute: comfort-index parameter range determination processing of determining, for one or more parameters of a plurality of parameters to be used for calculation of a comfort index, a range of possible values of each of the one or more parameters; comfort-index model generation processing of approximating the comfort index, on the basis of the values within the range determined for each of the one or more parameters, to generate a mathematical model of the comfort index; and setting value calculation processing of calculating, with the comfort index, setting values of one or more setting items for the one or more air conditioners on the basis of the mathematical model.

### Advantageous Effects of Invention

According to the present invention, the value of the comfort index can be calculated easily and accurately, and the setting values for the air conditioners can be calculated with the value of the comfort index.

### BRIEF DESCRIPTION OF DRAWINGS

FIG. 1 It depicts a schematic diagram illustrating the connection relationship between a setting value calculation system of the present invention and an air conditioner.

FIG. 2 It depicts a block diagram illustrating a configuration example of the setting value calculation system according to a first example embodiment of the present invention.

FIG. 3 It depicts an explanatory diagram illustrating an example of a table retained by a comfort-index parameter range setting value storage unit.

FIG. 4 It depicts an explanatory diagram illustrating an example of a table retained by a setting value calculation unit.

FIG. 5 It depicts a schematic diagram illustrating an example of a comfort index model M_{comfort} in form of a lookup table.

FIG. 6 It depicts a flowchart illustrating an exemplary processing flow of the first example embodiment.

FIG. 7 It depicts a schematic graph illustrating that limitation of a parameter range makes calculation of an approximation function simple, and the accuracy of the approximated value by the approximation function is increased.

FIG. 8 It depicts a block diagram illustrating a configuration example of a setting value calculation system that displays setting values.

FIG. 9 It depicts a block diagram illustrating a configuration example when no setting value is set in each air conditioner.

FIG. 10 It depicts a schematic block diagram illustrating a configuration example of a computer according to example embodiments of the present invention and modifications of the example embodiments.

FIG. 11 It depicts a block diagram illustrating the overview of the present invention.

### EXAMPLE EMBODIMENT

Hereinafter, example embodiments of the present invention will be described with reference to the drawings.

Note that in the following example embodiments, in some cases, even though the superscript and subscript of a variable are aligned and described in a mathematical formula, the superscript and subscript of the variable are displaced and described in the sentence. Even in such a case, if the symbol of the variable, the symbol in superscript, and the symbol in subscript are the same, the same variable is represented.

In addition, in the following example embodiments, there will be described, as an example, a case where the setting value calculation system of the present invention calculates setting values (set values) for air conditioners and sets the setting values in the air conditioners. FIG. 1 depicts a schematic diagram illustrating the connection relationship between the setting value calculation system of the present invention and the air conditioner. A setting value calculation system 1 and an air conditioner 51 are connected mutually. The setting value calculation system 1 calculates setting values for the air conditioner 51 and sets the setting values in the air conditioner 51 to control the air conditioner 51. Although the one air conditioner 51 is illustrated in FIG. 1, a plurality of air conditioners 51 in which the setting value calculation system 1 sets setting values, may exist. In addition, one or more types of parameters for setting setting values in the air conditioner 51 is provided. That is, one type of parameter may be provided, or a plurality of types of parameters may be provided. Examples of the parameters include supply air temperature and supply air volume. In addition, the types of parameters can be appropriately changed in accordance with the types of air conditioners.

The setting value calculation system 1 may be installed in the same building as the air conditioner 51, or may be installed in a place different from the building where the air conditioner 51 exists.

In addition, in the following example embodiments, a zone corresponding to an air conditioner on a one-to-one basis will be described as an air conditioning zone. That is, there will be described the air conditioning zone defined as a zone corresponding to an air conditioner on a one-to-one basis. However, the correspondence relationship between the air conditioning zone and the air conditioner can be expanded so as to allow a case where a plurality of air conditioners corresponds to one air conditioning zone. In addition, it can also be expanded such that the correspondence relationship between the air conditioning zone and the air conditioner is made on a many-to-many basis. Moreover, the air conditioning zone may be defined for each room of a building, or may be defined for each section according to a tenant.

Furthermore, such as described above, in the example embodiments, there will be described, as an example, a case where the setting value calculation system 1 of the present invention calculates setting values and sets the setting values in the air conditioner 51. However, the setting value calculation system 1 of the present invention may not set the setting values in the air conditioner 51. This case will be described later.

### First Example Embodiment

FIG. 2 depicts a block diagram illustrating a configuration example of the setting value calculation system according to a first example embodiment of the present invention. The setting value calculation system 1 of the present invention includes: an input unit 10, a comfort-index parameter range setting value storage unit 11; a setting value upper-and-lower limit range storage unit 12; an operation-plan setting value storage unit 13; a measured value acquisition unit 14; a comfort-index parameter range determination unit 15; a comfort index model generation unit 16; a setting value calculation unit 17; a predicted value acquisition unit 18; an air conditioning model storage unit 19; and an air conditioner control unit 20.

The input unit 10 receives inputs of various setting values to be stored in the comfort-index parameter range setting value storage unit 11, various setting values to be stored in the setting value upper-and-lower limit range storage unit 12, and setting value (operation-plan setting value) to be stored in the operation-plan setting value storage unit 13. The input unit 10 is realized by, for example, an input device.

The comfort-index parameter range setting value storage unit 11 stores the various setting values input from the input unit 10, and inputs the various setting values to the comfort-index parameter range determination unit 15 and the setting value calculation unit 17. The various setting values stored in the comfort-index parameter range setting value storage unit 11 will be described later.

The comfort-index parameter range setting value storage unit 11 is realized by, for example, a storage device, and a central processing unit (CPU) of a computer, the CPU operating according to a setting value calculation program. Note that the setting value calculation program is stored, for example, in a program recording medium such as a program storage device (not illustrated in FIG. 2) of the computer.

The setting value upper-and-lower limit range storage unit 12 stores the various setting values input from the input unit 10, and inputs the various setting values to the comfort-index parameter range determination unit 15 and the setting value calculation unit 17. The various setting values stored in the setting value upper-and-lower limit range storage unit 12 will be described later.

The setting value upper-and-lower limit range storage unit 12 is realized by, for example, the storage device and the CPU of the computer, the CPU operating according to the setting value calculation program.

The operation-plan setting value storage unit 13 stores the operation-plan setting value input from the input unit 10, and inputs the operation-plan setting value to the setting value calculation unit 17. The operation-plan setting value is a hyper parameter required when the setting value calculation unit 17 calculates a setting value. Specifically, the operation-plan setting value is, for example, a target value of a comfort index.

The operation-plan setting value storage unit 13 is realized by, for example, the storage device, and the CPU of the computer, the CPU operating according to the setting value calculation program.

The measured value acquisition unit 14 acquires various measured values measured by air conditioners that is the subject of operation, and inputs the various measured values to the comfort-index parameter range determination unit 15 and the setting value calculation unit 17.

For example, the measured value acquisition unit 14 acquires measured values of supply air temperature, supply air volume, temperature, outside air temperature, and solar radiation. Then, the comfort-index parameter range determination unit 15 and the setting value calculation unit 17 retain respective measured values of the supply air temperature, the supply air volume, the temperature, the outside air temperature, and the solar radiation at present and in past.

The measured value acquisition unit 14 is realized by, for example, a communication interface, and the CPU of the computer, the CPU operating according to the setting value calculation program.

The predicted value acquisition unit 18 acquires various predicted values, and inputs the various predicted values to the comfort-index parameter range determination unit 15 and the setting value calculation unit 17. For example, the predicted value acquisition unit 18 acquires predicted values of the outside air temperature, the solar radiation, and the ratio of number of people at each air conditioning zone, at each future time step. The predicted value acquisition unit 18 is required at least to acquire the respective predicted values thereof from a server device with the respective predicted values thereof retained, for example. The ratio of number of people will be described later.

The predicted value acquisition unit 18 is realized by, for example, the communication interface, and the CPU of the computer, the CPU operating according to the setting value calculation program.

The air conditioning model storage unit 19 stores various air conditioning models calculated in advance, and inputs the air conditioning models to the comfort-index parameter range determination unit 15, the comfort index model generation unit 16, and the setting value calculation unit 17. Each air conditioning model is a model for calculation of values of predetermined items when input values are given. Examples of the air conditioning model include a temperature model that calculates the temperature at a successive time step. The air conditioning model used in the present invention will be appropriately described later.

The air conditioning model storage unit 19 is realized by, for example, the storage device, and the CPU of the computer, the CPU operating according to the setting value calculation program.

In addition, a parameter for calculating a comfort index hereinafter referred to as a comfort-index calculation parameter (or simply, calculation parameter). In the example embodiments, there will be described, as an example, a case where temperature, radiation temperature, relative humidity, supply air volume, clothing insulation, and metabolic rate are used as comfort-index calculation parameters. Note that the supply air volume can be calculated from the airflow speed.

The comfort-index parameter range determination unit 15 determines the possible range of values of each comfort-index calculation parameter, on the basis of the various setting values input from the comfort-index parameter range setting value storage unit 11, the various setting values input from the setting value upper-and-lower limit range storage unit 12, the various measured values input from the measured value acquisition unit 14, the various predicted values input from the predicted value acquisition unit 18, and the various air conditioning models input from the air conditioning model storage unit 19. Then, the comfort-index parameter range determination unit 15 inputs the possible ranges of values of the calculation parameters, to the comfort index model generation unit 16.

The comfort-index parameter range determination unit 15 is realized by, for example, the CPU of the computer, the CPU operating according to the setting value calculation program.

The comfort index model generation unit 16 generates a comfort index model that calculates the comfort index, on the basis of the possible ranges of values of the comfort-index calculation parameters and then inputs the comfort index model to the setting value calculation unit 17.

The comfort index model generation unit 16 is realized by, for example, the CPU of the computer, the CPU operating according to the setting value calculation program, for example.

The setting value calculation unit 17 calculates setting values of one or more setting items for one or more air conditioners to be controlled, on the basis of the various setting values input from the setting value upper-and-lower limit range storage unit 12, the operation-plan setting value input from the operation-plan setting value storage unit 13, the various measured values input from the measured value acquisition unit 14, the various predicted values input from the predicted value acquisition unit 18, the various air conditioning models input from the air conditioning model storage unit 19, and the comfort index model input from the comfort index model generation unit 16. The setting value calculation unit 17 inputs each calculated setting value to the air conditioner control unit 20.

The setting value calculation unit 17 is realized, for example, by the CPU of the computer, the CPU operating according to the setting value calculation program.

The air conditioner control unit 20 updates the setting values for the air conditioners corresponding to the setting values calculated by the setting value calculation unit 17, on the basis of the various setting values input from the setting value calculation unit 17, for example.

As a result, the air conditioner control unit 20 controls the air conditioners.

The air conditioner control unit 20 is realized by, for example, the communication interface, and the CPU of the computer, the CPU operating according to the setting value calculation program.

Next, the constituent elements such as the comfort-index parameter range setting value storage unit 11 will be described more specifically.

FIG. 3 depicts an explanatory diagram illustrating an example of a table retained by the comfort-index parameter range setting value storage unit 11. As attributes for temperature [degrees Celsius], relative humidity [%], radiation temperature [degrees Celsius], airflow speed [m/s], clothing insulation [clo], and metabolic rate [met], a table 110 illustrated in FIG. 3 stores the attribute values of setting value validity, setting lower limit, setting upper limit, legal lower limit, and legal upper limit. Note that the temperature, the relative humidity, the radiation temperature, the clothing insulation, and the metabolic rate correspond to the comfort-index calculation parameters. The airflow speed is used for calculation of the supply air volume that is one of the calculation parameters. That is, the lower limit and the upper limit of the supply air volume can be calculated from the lower limit and upper limit of the airflow speed.

The comfort-index parameter range setting value storage unit 11 is capable of updating the attribute values of the setting value validity, the setting lower limit, and the setting upper limit, on the basis of setting values input though the input unit 10. Note that FIG. 3 depicts the table as the explanatory diagram illustrated schematically. When inputting setting values to be stored in the comfort-index parameter range setting value storage unit 11, a user may input the setting values though a graphic user interface (GUI) similar to the form illustrated schematically in FIG. 3.

The setting lower limit and the setting upper limit are values specified by the user, as the lower limit and the upper limit indicating the possible range of the corresponding calculation parameter in comfort index calculation.

The setting value validity is an attribute indicating whether the values stored as the setting lower limit and setting upper limit of the corresponding parameter are valid or invalid. In addition to the setting lower limit and the setting upper limit, as the lower limit and upper limit of a parameter, the legal lower limit and the legal upper limit as illustrated in FIG. 3, and a model lower limit and a model upper limit are provided. The legal lower limit and the legal upper limit are the lower limit and upper limit of the possible range of the parameter, the legal lower limit and the legal upper limit being specified by a building management law (e.g., “Law for Maintenance of Sanitation in Buildings” in Japan). The model lower limit and the model upper limit are respectively the lower limit and upper limit of the parameter to be calculated by the comfort-index parameter range determination unit 15, on the basis of a model (air conditioning model) that can calculate possible values of the parameter and the upper-and-lower limit ranges of setting values to be stored in the setting value upper-and-lower limit range storage unit 12 (see FIG. 4 to be described later). However, the model lower limit and the model upper limit are calculated regarding the temperature and the radiation temperature.

When the attribute value of the setting value validity is “invalid”, whether the upper limit of the parameter is defined by comparison between the legal upper limit and the model upper limit, or whether the upper limit of the parameter is defined on the basis of the legal upper limit, or whether the upper limit of the parameter is defined by the model upper limit depends on the type of parameter. In addition, when the attribute value of the setting value validity is “valid”, whether the upper limit of the parameter is defined by comparison between the legal upper limit and the setting upper limit or whether the upper limit of the parameter is defined on the basis of the setting upper limit depends on the type of parameter. These points are similar to those for the lower limit of the parameter.

As for the radiation temperature, the upper limit and the lower limit are not specified by law. Thus, in the table 110, the fields of the legal lower limit and legal upper limit of the radiation temperature are blank.

As for the clothing insulation, when the comfort index is calculated, one setting value is used as a possible value of the clothing insulation. Thus, in the table 110, the field of the setting value validity of the clothing insulation is blank, and the setting lower limit and the setting upper limit of the clothing insulation are identical in value. In addition, the upper limit and lower limit of the clothing insulation are not specified by law. Thus, in the table 110, the fields of the legal lower limit and legal upper limit of the clothing insulation are blank.

As for the metabolic rate, when the comfort index is calculated, one setting value is used as a possible value of the metabolic rate. Therefore, in the table 110, the field of the setting value validity of the metabolic rate is blank, and the setting lower limit and setting upper limit of the metabolite are identical in value. In addition, the upper limit and lower limit of the metabolic rate are not specified by law. Thus, in table 110, the fields of the legal lower limit and legal upper limit of the metabolic rate are blank.

For each of the one or more setting items for the one or more air conditioners to be controlled, the setting value upper-and-lower limit range storage unit 12 retains a table that can store the lower limit and upper limit of the setting values per air conditioner to be calculated by the setting value calculation unit 17. FIG. 4 depicts an explanatory diagram illustrating an example of this table. FIG. 4 exemplifies a table storing the lower limit and upper limit of the supply air temperature and the lower limit and upper limit of the supply air volume of each air conditioner. Note that the number of setting items for the air conditioners is not limited to two, and may be at least one.

Note that FIG. 4 depicts the table as the explanatory diagram illustrated schematically. When inputting the lower limit and the upper limit of the setting values to be calculated by the setting value calculation unit 17, the user may input the lower limit and the upper limit of the setting values though a GUI similar to the form illustrated schematically in FIG. 4.

The operation-plan setting value storage unit 13 stores, as the operation-plan setting value, the hyper parameter required when the setting value calculation unit 17 calculates the setting values. Specifically, the operation-plan setting value storage unit 13 stores the target value of the comfort index.

The comfort-index parameter range determination unit 15 determines the lower limit and upper limit of the possible range of each calculation parameter, on the basis of the setting value validity, the setting lower limit and the setting upper limit, the legal lower limit and the legal upper limit, and the model lower limit and the model upper limit. However, regarding each parameter of which the model lower limit and the model upper limit are not calculated, the comfort-index parameter range determination unit 15 does not use the model lower limit and the model upper limit. In addition, regarding each parameter of which the legal lower limit and the legal upper limit are not defined and the fields thereof are blank, the comfort-index parameter range determination unit 15 does not use the legal lower limit and the legal upper limit.

As will be apparent from the expressions to be described later, when the attribute value of the setting value validity is “invalid”, the setting lower limit and the setting upper limit are respectively multiplied by 0. Thus, the setting lower limit and the setting upper limit do not affect the results. Therefore, when the attribute value of the setting value validity is “invalid”, the user does not need know-how when inputting appropriate values as the setting lower limit and the setting upper limit. As a result, the burden of defining the appropriate setting lower limit and setting upper limit is reduced for the user. Hereinafter, in the first example embodiment, there will be described with assumption that all attribute values of the setting value validity of the temperature, the relative humidity, the radiation temperature, and the airflow speed are “invalid”.

The comfort-index parameter range determination unit 15 calculates the upper limit of the temperature, the lower limit of the temperature, the upper limit of the radiation temperature, the lower limit of the radiation temperature, the upper limit of the relative humidity, the lower limit of the relative humidity, the upper limit of the airflow speed, and the lower limit of the airflow speed, with Expressions (1) to (8) described below:

[Mathematical Formula 1]

uT^{air}=minimum{uT^{air,legal},m^{air}uT^{air,setting}+(1−m^{air})uT^{air,model}} (1)

[Mathematical Formula 2]

dT^{air}=maximum{dT^{air,legal},m^{air}dT^{air,setting}+(1−m^{air})dT^{air,model}} (2)

[Mathematical Formula 3]

uT^{bldg}=m^{bldg}uT^{bldg,setting}+(1−m^{bldg})UT^{bldg,model} (3)

[Mathematical Formula 4]

dT^{bldg}=m^{bldg}dT^{bldg,setting}+(1−m^{bldg})dT^{bldg,model} (4)

[Mathematical Formula 5]

uT^{humid}=(1−m^{humid})uT^{humid,legal}+m^{humid}uT^{humid,setting} (5)

[Mathematical Formula 6]

dT^{humid}=(1−m^{humid})dT^{humid,legal}+m^{humid}uT^{humid,setting} (6)

[Mathematical Formula 7]

uT^{airspeed}=(1−m^{airspeed})uT^{airspeed,legal}+m^{airspeed}uT^{airspeed,setting} (7)

[Mathematical Formula 8]

dT^{airspeed}=(1−m^{airspeed})dT^{airspeed,legal}+m^{airspeed}dT^{airspeed,setting} (8)

uT^{air} represents the upper limit of the temperature. dT^{air} represents the lower limit of the temperature. uT^{air,legal} represents the legal upper limit of the temperature. dT^{air,legal} represents the legal lower limit of the temperature. uT^{air,setting} represents the setting upper limit of the temperature. dT^{air,setting} represents the setting lower limit of the temperature. uT^{air,model} represents the model upper limit of the temperature. dT^{air,model} represents the model lower limit of the temperature. m^{air} represents the binary value (1: valid, 0: invalid) indicating the setting value validity of the temperature.

uT^{bldg} represents the upper limit of the radiation temperature. dT^{bldg} represents the lower limit of the radiation temperature. uT^{bldg,setting} represents the setting upper limit of the radiation temperature. dT^{bldg,setting} represents the setting lower limit of the radiation temperature. uT^{bldg,model} represents the model upper limit of the radiation temperature. dT^{bldg,model} represents the model lower limit of the radiation temperature. m^{bldg} represents the binary value (1: valid, 0: invalid) indicating the setting value validity of the radiation temperature.

uT^{humid} represents the upper limit of the relative humidity. dT^{humid} represents the lower limit of the relative humidity. uT^{humid,legal} represents the legal upper limit of the relative humidity. dT^{humid,legal} represents the legal lower limit of the relative humidity. uT^{humid,setting} represents the setting upper limit of the relative humidity. dT^{humid,setting} represents the setting lower limit of the relative humidity. m^{humid} represents the binary value (1: valid, 0: invalid) indicating the setting value validity of the relative humidity.

uT^{airspeed} represents the upper limit of the airflow speed. dT^{airspeed} represents the lower limit of the airflow speed. uT^{airspeed,legal} represents the legal upper limit of the airflow speed. dT^{airspeed,legal} represents the legal lower limit of the airflow speed. uT^{airspeed,setting} represents the setting upper limit of the airflow speed. dT^{airspeed,setting} represents the setting lower limit of the airflow speed. m^{airspeed} represents the binary value (1: valid, 0: invalid) indicating the setting value validity of the airflow speed.

In addition, the comfort-index parameter range determination unit 15 calculates the model upper limit of the temperature, the model lower limit of the temperature, the model upper limit of the radiation temperature, and the model lower limit of the radiation temperature, with Expressions (9) to (12) described below:

$$\begin{matrix}[ Mathematical Formula 9 ] & \\ u {T}^{a i r , m o d e l} = {maximum}_{{{s}_{t , n}^{Ts} ∀ n , t}_{{{s}_{t , n}^{Qs } ∀ n , t}_{∀ n , t}}} ( {T}_{t , n}^{air} ) & ( 9 ) \\ [ Mathematical Formula 10 ] & \\ {dT}^{a i r , m o d e l} = {minimum}_{{{s}_{t , n}^{T s} ∀ n , t}_{{{s}_{t , n}^{Qs } ∀ n , t}_{∀ n , t}}} ( {T}_{t , n}^{air} ) & ( 10 ) \\ [ Mathematical Formula 11 ] & \\ u {T}^{bldg , model} = {maximum}_{{{s}_{t , n}^{Ts} ∀ n , t}_{{{s}_{t , n}^{Qs } ∀ n , t}_{∀ n , t}}} ( {T}_{t , n}^{b l d g} ) \\ [ Mathematical Formula 12 ] & ( 11 ) \\ d {T}^{bldg , model} = {minimum}_{{{s}_{t , n}^{T s} ∀ n , t}_{{{s}_{t , n}^{Qs } ∀ n , t}_{∀ n , t}}} ( {T}_{t , n}^{bldg} ) & ( 12 )\end{matrix}$$

Here, the comfort-index parameter range determination unit 15 calculates T^{air}ₜ₊₁ and T^{bldg}ₜ₊₁, respectively, with Expressions (13) and (14) described below:

[Mathematical Formula 13]

Tₜ₊₁^{air}=Mₜₑₘₚ^{air}(Sₜ^{Qs},Sₜ^{Ts},Tₜ^{air},Tₜ^{bldg},Cₜ^{outside},Cₜ^{solar})∀t (13)

[Mathematical Formula 14]

Tₜ₊₁^{bldg}=Mₜₑₘₚ^{bldg}(Sₜ^{Qs},Sₜ^{Ts},Tₜ^{air},Tₜ^{bldg},Cₜ^{outside},Cₜ^{solar})∀t (13)

In addition, T^{air}ₜ, T^{bldg}ₜ, s^{Ts}ₜ, and s^{Qs}ₜ are expressed as Expressions (15) to (18) described below:

$$\begin{matrix}[ Mathematical Formula 15 ] & \\ {T}_{t}^{a i r} = [ \begin{matrix}{T}_{t , 1}^{a i r} \\ {T}_{t , 2}^{a i r} \\ ⋮ \\ {T}_{t , N}^{a i r}\end{matrix} ] ∀ r \\ [ Mathematical Formula 16 ] & ( 15 ) \\ {T}_{t}^{bldg} = [ \begin{matrix}{T}_{t , 1}^{bldg} \\ {T}_{t , 2}^{bldg} \\ ⋮ \\ {T}_{t , N}^{bldg}\end{matrix} ] ∀ t & ( 16 ) \\ [ Mathematical Formula 17 ] & \\ {S}_{t}^{T s} = [ \begin{matrix}{s}_{t , 1}^{T s} \\ {s}_{t , 2}^{T s} \\ ⋮ \\ {s}_{t , N}^{T s}\end{matrix} ] ∀ t & ( 17 ) \\ [ Mathematical Formula 18 ] & \\ {s}_{t}^{Q s} = [ \begin{matrix}{s}_{t , 1}^{Q s} \\ {s}_{t , 2}^{Q s} \\ ⋮ \\ {s}_{t , N}^{Q s}\end{matrix} ] ∀ t & ( 18 )\end{matrix}$$

Furthermore, the possible range of s^{Ts}_{t,n}, and the possible range of s^{Qs}_{t,n} are expressed, respectively, by Expressions (19) and (20) described below:

[Mathematical Formula 19]

ds_{t,n}^{Ts}≤S_{t,n}^{Ts}≤us_{t,n}^{Ts}∀n,t (19)

[Mathematical Formula 20]

ds_{t,n}^{Qs}≤S_{t,n}^{Qs}≤us_{t,n}^{Qs}∀n,t (20)

Here, T^{air}_{t,n} represents the temperature at a time step t and an air conditioning zone n. T^{bldg}_{t,n} represents the radiation temperature at the time step t and the air conditioning zone n. s^{Ts}_{t,n} represents the supply air temperature at the time step t and the air conditioning zone n, us^{Ts}_{t,n} represents the upper limit of s^{Ts}_{t,n}, and ds^{Ts}_{t,n} represents the lower limit of s^{Ts}_{t,n}. s^{Qs}_{t,n} represents the supply air volume at the time step t and the air conditioning zone n, us^{Qs}_{t,n} represents the upper limit of s^{Qs}_{t,n}, and ds^{Qs}_{t,n} represents the lower limit of s^{Qs}_{t,n}.

M^{air}ₜₑₘₚ is one of the air conditioning models prestored in the air conditioning model storage unit 19, and is an air conditioning model used for calculation of the temperature at a successive time step. Hereinafter, M^{air}ₜₑₘₚ referred to as a temperature model.

M^{bldg}ₜₑₘₚ is one of the air conditioning models prestored in the air conditioning model storage unit 19, and is an air conditioning model used for calculation of the radiation temperature at the successive time step. Hereinafter, M^{bldg}ₜₑₘₚ is referred to as a radiation temperature model.

C^{outside}ₜ represents the outside air temperature at the time step t. C^{solar}ₜ at represents the solar radiation at the time step t.

Moreover, as already described, in the example embodiments, the zone corresponding to an air conditioner on a one-to-one basis will be describes as the air conditioning zone. However, the correspondence relationship between the air conditioning zone and the air conditioner can be expanded more widely.

The comfort-index parameter range determination unit 15 calculates the temperature T^{air}ₜ₊₁ at a successive time step t+1, with the temperature model M^{air}ₜₑₘₚ (see Expression (13)), and data at a certain time step t. The comfort-index parameter range determination unit 15 repeats this computation and calculates the temperature at each future time step.

Similarly, the comfort-index parameter range determination unit 15 calculates the radiation temperature T^{bldg}ₜ₊₁ at the successive time step t+1, with the radiation temperature model M^{bldg}ₜₑₘₚ (see Expression (14)) and data at the certain time step t. The comfort-index parameter range determination unit 15 repeats this computation and calculates the radiation temperature at each future time step.

In addition, the comfort-index parameter range determination unit 15 may use the present supply air volume, the present supply air temperature, the present temperature, the present outside air temperature, the present solar radiation acquired by the measured value acquisition unit 14, as the initial values of s^{Qs}ₜ, s^{Ts}ₜ, T^{air}ₜ, C^{outside}ₜ, and C^{solar}ₜ in each of processing of calculating the temperature at each future time step, with the temperature model M^{air}ₜₑₘₚ and processing of calculating the radiation temperature at each future time step, with the radiation temperature model M^{bldg}ₜₑₘₚ. Moreover, in general, the radiation temperature is not measured periodically. Thus, in order to obtain the present radiation temperature, the comfort-index parameter range determination unit 15 performs the computation below. The air conditioning model storage unit 19 prestores the radiation temperature at a certain past time step (defined as p). In addition, the comfort-index parameter range determination unit 15 retains the measured values of the supply air temperature, the supply air volume, the temperature, the outside air temperature, and the solar radiation amount at each past time step acquired by the measured value acquisition unit 14. Therefore, the air conditioning model storage unit 19 can derive the present radiation temperature by repeating the computation with the radiation temperature model M^{bldg}ₜₑₘₚ starting from the past time step p. The comfort-index parameter range determination unit 15 may use the present radiation temperature derived as described above, as the initial value of T^{bldg}ₜ in each of the processing of calculating the temperature at each future time step, with the temperature model M^{air}ₜₑₘₚ and the processing of calculating the radiation temperature at each future time step, with the radiation temperature model M^{bldg}ₜₑₘₚ.

Moreover, the comfort-index parameter range determination unit 15 may use the outside air temperature and the solar radiation at each future time step obtained from the predicted value acquisition unit 18, as C^{outside}ₜ and C^{solor}ₜ at each future time step.

Furthermore, the comfort-index parameter range determination unit 15 uses a combination of various values of s^{Qs}_{t,n} within the range of possible values of s^{Qs}_{t,n} and various values of s^{Ts}_{t,n} within the range of possible values of s^{Ts}_{t,n}, as a combination of s^{Qs}_{t,n} and s^{Ts}_{t,n} at each future time step. Then, for each combination, the comfort-index parameter range determination unit 15 calculates T^{air}ₜ and T^{bldg}ₜ at each future time step corresponding to the combination.

Furthermore, the setting value calculation unit 17 also performs processing of calculating the temperature at each future time step, with the temperature model M^{air}ₜₑₘₚ, and processing of calculating the radiation temperature at each future time step, with the radiation temperature model M^{bldg}ₜₑₘₚ. The processing by the setting value calculation unit 17 is similar to the processing by the comfort-index parameter range determination unit 15 as described above.

The comfort-index parameter range determination unit 15 calculates the model upper limit uT^{air,model} of temperature with Expression (9). That is, the comfort-index parameter range determination unit 15 finds out a combination of the supply air temperature and the supply air volume maximizing a maximum temperature among the temperatures of all time steps and all air conditioning zones, from the upper-and-lower limit range of the supply air temperature and the upper-and-lower limit range of the supply air volume, and calculates the maximum temperature with the combination, as the model upper limit uT^{air,model} of the temperature. After calculating uT^{air,model}, the comfort-index parameter range determination unit 15 calculates the upper limit uT^{air} of the temperature with Expression (1).

The comfort-index parameter range determination unit 15 calculates the model lower limit dT^{air,model} of the temperature with Expression (10). That is, the comfort-index parameter range determination unit 15 finds out a combination of the supply air temperature and the supply air volume minimizing a minimum temperature among the temperatures of all time steps and all air conditioning zones, from the upper-and-lower limit range of the supply air temperature and the upper-and-lower limit range of the supply air volume, and calculates the minimum temperature with the combination, as the model lower limit dT^{air,model} of the temperature. After calculating dT^{air,model} the comfort-index parameter range determination unit 15 calculates the lower limit dT^{air} of the temperature with Expression (2).

The comfort-index parameter range determination unit 15 calculates the model upper limit uT^{bldg,model} of the radiation temperature with Expression (11). That is, the comfort-index parameter range determination unit 15 finds out a combination of the supply air temperature and the supply air volume maximizing a maximum radiation temperature among the radiation temperatures of all time steps and all air conditioning zones, from the upper-and-lower limit range of the supply air temperature and the upper-and-lower limit range of the supply air volume, and calculates the maximum radiation temperature with the combination, as the model upper limit uT^{bldg,model} of the radiation temperature. After calculating uT^{bldg,model} the comfort-index parameter range determination unit 15 calculates the upper limit uT^{bldg} of the radiation temperature with Expression (3).

The comfort-index parameter range determination unit 15 calculates the model lower limit dT^{bldg,model} of the radiation temperature with Expression (12). That is, the comfort-index parameter range determination unit 15 finds out a combination of the supply air temperature and the supply air volume minimizing a minimum radiation temperature among the radiation temperatures of all time steps and all air conditioning zones, from the upper-and-lower limit range of the supply air temperature and the upper-and-lower limit range of the supply air volume, and calculates the minimum radiation temperature with the combination, as the model lower limit dT^{bldg,model} of the radiation temperature. After calculating dT^{bldg,model} the comfort-index parameter range determination unit 15 calculates the lower limit dT^{bldg} of the radiation temperature with Expression (4).

In addition, the comfort-index parameter range determination unit 15 calculates the upper limit of the airflow speed with Expression (7), and calculates the upper limit of the supply air volume from the upper limit of the airflow speed. Similarly, the comfort-index parameter range determination unit 15 calculates the lower limit of the airflow speed with Expression (8), and calculates the lower limit of the supply air volume from the lower limit of the airflow speed. The air conditioning model storage unit 19 stores an air conditioning model (hereinafter, referred to as an airflow speed model) that transforms the supply air volume to the airflow speed. The comfort-index parameter range determination unit 15 can calculate the upper limit of the supply air volume by performing inverse transformation of the airflow speed model to the upper limit of the airflow speed. Similarly, the comfort-index parameter range determination unit 15 can calculate the lower limit of the supply air volume by performing inverse transformation of the airflow speed model to the lower limit of airflow speed.

Moreover, the comfort-index parameter range determination unit 15 calculates the upper limit uT^{humid} of the relative humidity with Expression (5), and calculates the lower limit dT^{humid} of the relative humidity with Expression (6).

Note that regarding the clothing insulation, one value is set by the user (see FIG. 3), and the value is used as the constant of the clothing insulation. Similarly, regarding the metabolic rate, one value is set by the user (see FIG. 3), and the value is used as the constant of the metabolic rate.

Such as described above, in the example embodiments, a case where temperature, radiation temperature, relative humidity, supply air volume, clothing insulation, and metabolic rate are used as comfort-index calculation parameters is taken as an example. The comfort-index parameter range determination unit 15 input, to the comfort index model generation unit 16, the upper limit uT^{air} of the temperature, the lower limit dT^{air} of the temperature, the upper limit uT^{bldg} of the radiation temperature, the lower limit dT^{bldg} of the radiation temperature, the upper limit uT^{humid} of the relative humidity, the lower limit dT^{humid} of the relative humidity, the upper limit of the supply air volume, the lower limit of the supply air volume, the setting value (constant) of the clothing insulation, and the setting value (constant) of the metabolic rate. uT^{air} and dT^{air} represent the range of possible values of the temperature. uT^{bldg} and dT^{bldg} represent the range of possible value of the radiation temperature. uT^{humid} and dT^{humid} represent the range of possible values of the relative humidity. The upper limit and lower limit of the supply air volume represent the range of possible values of the supply air volume.

The comfort index model generation unit 16 calculates a comfort index model M_{comfort} for calculating a comfort index, on the basis of the data input from the comfort-index parameter range determination unit 15. The comfort index model M_{comfort} derives a value of the comfort index (hereinafter, referred to as comfort index value), with the values of the temperature, the radiation temperature, the relative humidity, the supply air volume, the clothing insulation, and the metabolic rate as input values. The comfort index model M_{comfort} is expressed as a function, for example. It can be said that the comfort index model M_{comfort} is a mathematical model of the comfort index.

In the present example embodiment, there will be described, as an example, a case where the absolute value of PMV is adopted as the comfort index.

The comfort index model M_{comfort} has a relationship with the comfort index, expressed by Expression (21) below:

[Mathematical Formula 21]

|PMV(T^{air},T^{bldg},M_{airspeed}(T^{Qs}),C^{humid},C^{cloth},C^{mets})|˜M_{comfort}(T^{air},T^{bldg},T^{Qs},C^{humid},C^{cloth},C^{mets}) (21)

In Expression (21), “˜” represents that the left side of “^{˜}” can be approximated by the right side of “^{˜}”. In addition, Tai represents the temperature. T^{bldg} represents the radiation temperature. T^{Qs} represents the supply air volume. C^{humid} represents the relative humidity. C^{cloth} represents the clothing insulation. C^{mets} represents the metabolic rate. M_{airspeed} represents the airflow speed model. As described above, the airflow speed model is the air conditioning model that transforms the supply air volume to the airflow speed, and is one of the air conditioning models stored in the air conditioning model storage unit 19.

PMV represented on the left side of Expression (21) is a function that returns a value of PMV, with the values of the temperature, the radiation temperature, the relative humidity, the airflow speed (airflow speed transformed from the supply air volume), the clothing insulation, and the metabolic rate as input values. A function described in NPL 1 may be used as PMV represented on the left side of Expression (21), for example.

The comfort index model generation unit 16 derives a plurality of combinations of the absolute value of PMV with each value of T^{air}, T^{bldg}, T^{Qs}, C^{humid}, C^{cloth} and C^{mets}, on the basis of PMV represented on the left side of Expression (21) and each value of T^{air}, T^{bldg} T^{Qs}, C^{humid}, C^{cloth}, and C^{mets}. At this time, the comfort index model generation unit 16 is required at least to sample each value of T^{air}, T^{bldg}, T^{Qs}, and C^{humid} from the range of possible values of each calculation parameter input from the comfort index model generation unit 16. In addition, as described above, C^{cloth} and C^{mets} are the constants set by the user.

The comfort index model generation unit 16 derives the plurality of combinations of the absolute value of PMV and each value of T^{air}, T^{bldg}, T^{Qs}, C^{humid}, C^{cloth}, and C^{mets}, and then, with the plurality of combinations as learning data, calculates coefficients and a constant term in a linear regression expression or a nonlinear regression expression for acquisition of M_{comfort}. For example, the comfort index model generation unit 16 samples each value of T^{air}, T^{bldg}, T^{Qs}, and C^{humid} from the possible ranges of those values, and derives the plurality of combinations described above. Then, the comfort index model generation unit 16 performs supervised learning to calculate regression coefficients and a constant term in a linear regression expression. As a result, the linear regression expression for acquisition of M_{comfort} is obtained, and a comfort index value (approximated value of the absolute value of PMV value) can be calculated, with each value of T^{air}, T^{bldg}, T^{Qs}, C^{humid}, C^{cloth} and C^{mets} as input values.

Alternatively, the comfort index model generation unit 16 may calculate the comfort index model M_{comfort} by machine learning such as a neural network.

In addition, the comfort index model M_{comfort} may be in form of a lookup table. FIG. 5 depicts a schematic diagram illustrating an example of the comfort index model M_{comfort} in form of a lookup table. In the following description, there will be described, as an example, a case where a lookup table is created with three parameters of the temperature, the radiation temperature, and the airflow speed as indices, and the relative humidity, the clothing insulation, and the metabolic rate as constants. The comfort index model generation unit 16 partitions the possible range of the temperature represented by uT^{air} and dT^{air}, for each constant value, into several intervals. Similarly, the comfort index model generation unit 16 partitions the possible range of the radiation temperature represented by uT^{bldg} and dT^{bldg}, for each constant value, into several intervals. Similarly, the comfort index model generation unit 16 partitions the possible range of the airflow speed represented by uT^{airspeed} and dT^{airspeed}, for each constant value, into several intervals. In addition, the comfort index model generation unit 16 samples one value from the possible range of the relative humidity, and uses the value as a constant. Moreover, the clothing insulation and the metabolic rate are constants.

For each combination of one interval of the temperature, one interval of the radiation temperature, and one interval of the airflow speed, the comfort index model generation unit 16 calculates a comfort index value (value of PMV) according to the combination, on the basis of the intermediate value of the interval of the temperature, the intermediate value of the interval of the radiation temperature, the intermediate value of the interval of the airflow speed, and the relative humidity, the clothing insulation, and the metabolic rate as the constants. The comfort index model generation unit 16 creates a lookup table to which the comfort index value can be referred, from a combination of optional one interval of the temperature, optional one interval of the radiation temperature, and optional one interval of the airflow speed. FIG. 5 illustrates an example of such a lookup table. In the example illustrated in FIG. 5, in the table T1 regarding the temperature, the ID of a table to be referred to (table regarding the radiation temperature) is associated with each interval of the temperature. A table regarding the radiation temperature is created for each interval of the temperature. In each table regarding the radiation temperature, the ID of a table to be referred to (table regarding the airflow speed) is associated with each interval of the radiation temperature. A table regarding the airflow speed is created for each interval of the radiation temperature in the table regarding an individual radiation temperature. In each table regarding the airflow speed, a comfort index value is associated with each interval of the airflow speed.

Such a lookup table enables specifying a comfort index value according to a combination of a value of the temperature, a value of the radiation temperature, and a value of the airflow speed. That is, a table regarding the radiation temperature is specified from the interval to which the value of temperature belongs. In the table regarding the radiation temperature, a table regarding the airflow speed is specified from the interval to which the value of the radiation temperature belongs. In the table regarding the airflow speed, a comfort index value is specified from the interval to which the value of the airflow speed belongs.

Generation of the lookup table such as described above enables obtaining the comfort index value (value of PMV), from the combination of the value of the temperature, the value of the radiation temperature, and the value of the airflow speed. Note that, when the supply air volume is given, air volume is required at least to be transformed to the airflow speed by the airflow speed model.

In addition, FIG. 5 illustrates an example of an implementation form of a lookup table, and the form of the lookup table is not limited particularly.

The range of the temperature, the range of the radiation temperature, and the range of the airflow speed are each limited; thus, size of the lookup table can be reduced. Moreover, the intervals of the temperature, the radiation temperature, and the airflow speed can be each detailed; thus, the accuracy of the comfort index value (value of PMV) can be increased.

The comfort index model generation unit 16 inputs the generated comfort index model M_{comfort} to the setting value calculation unit 17.

The setting value calculation unit 17 calculates setting values minimizing an air-conditioning power amount within a constant range of the comfort index. The setting value calculation unit 17 solves an optimization problem in which the objective function is expressed by Expression (22) described below, and the constraint conditions are expressed by Expressions (13) to (20) described above and Expressions (23) to (25) described below, to calculate setting values such as described above. It can be said that the setting value calculation unit 17 solves an optimization problem minimizing the amount of power consumption, with the comfort index as a constraint condition, to calculate setting values. Note that the amount of power consumption is an example of an air conditioning operation cost. The setting value calculation unit 17 may solve an optimization problem minimizing an air conditioning operation cost different from the amount of power consumption.

$$\begin{matrix}[ Mathematical Formula 22 ] & \\ {minimize}_{{{s}_{t , n}^{T s} ∀ n , t}_{{s}_{t , n}^{Q S} ∀ n , t}} {{\sum }^{T}}_{t = 1} {P}_{t} & ( 22 ) \\ [ Mathematical Formula 23 ] & \\ {P}_{t} = {M}_{power} ( {S}_{t}^{Qs} , {S}_{t}^{Ts} , {T}_{t}^{air} ) ∀ t & ( 23 ) \\ [ Mathematical Formula 24 ] & \\ {c}_{t , n} = {M}_{comfort} ( {T}_{t , n}^{air} , {T}_{t , n}^{bldg} , {s}_{t , n}^{Qs} , {C}^{humid} , {C}^{cloth} , {C}^{mets} ) ∀ n , t & ( 24 ) \\ [ Mathematical Formula 25 ] & \\ {\sum }_{t = 1}^{T} {\sum }_{n = 1}^{N} {w}_{t , n} {c}_{t , n} \leq {c}^{target} & ( 25 )\end{matrix}$$

Pₜ represents air conditioning power at individual time step t on and after the present time. Therefore, the part representing the summation of Pₜ in Expression (22) represents the air-conditioning power amount in the time zone from the present time to a predetermined future time (e.g., time zone from the present time to eight hours later).

M_{power} represents an air conditioning model for calculation of the air-conditioning power at each time step. Hereinafter, this M_{power} is referred to as an air conditioning power model. The air conditioning power model M_{power} is one of the air conditioning models prestored in the air conditioning model storage unit 19. For each time step on and after the present time, the setting value calculation unit 17 calculates the air conditioning power Pₜ, with the supply air volume, the supply air temperature, and the temperature (indoor temperature) at the time step of interest as inputs to the air conditioning power model M_{power}.

In addition, c_{t,n} represents the comfort index value at the time step t and the air conditioning zone n. c_{t,n} represents a real number greater than or equal to 0, and the smaller the value of c_{t,n} is, the higher the comfort is. w_{t,n} represents the weight coefficient of the comfort index value c_{t,n} and the sum total thereof is 1. c^{target} represents the target value of the comfort index.

The setting value calculation unit 17 calculates the comfort index value at each time step and each air conditioning zone on and after the present time, with Expression (24).

In addition, Expression (25) represents a constraint condition that the weighted mean value of the comfort index value at each time step and each air conditioning zone on and after the present time is to be the target value of the comfort index or less.

It is preferable to use, as the weight coefficient w_{t,n}, the predicted value of the ratio of number of people at each time step and each air conditioning zone. The predicted value acquisition unit 18 acquires the predicted value of the ratio of number of people at each time step and each air conditioning zone.

Here, the ratio of number of people at the time step t and the air conditioning zone n is defined as r_{t,n}. In addition, the number of people at the time step t and the air conditioning zone n is defined as num_{t,n}. The ratio of number of people r_{t,n} is the value defined as r_{t,n}=num_{t,n}/ΣₜΣₙnum_{t,n}.

Moreover, when the predicted value acquisition unit 18 cannot acquire the predicted value of the ratio of number of people at each time step and each air conditioning zone, the value of the weight coefficient w_{t,n} may be uniformly defined as 1/TN. T represents the number of time steps from the present time to a predetermined future time (e.g., time after 8 hours). In addition, N represents the number of air conditioning zones.

In addition, in order to calculate, with Expression (24), the comfort index value at each time step and each air conditioning zone on and after the present time, the setting value calculation unit 17 calculates the temperature T^{air}_{t,n} at each time step and each air conditioning zone on and after the present time and T^{bldg}_{t,n} at each time step and each air conditioning zone on and after the present time. This computation is similar to the processing of calculating the temperature at each future time step, with the temperature model M^{air}ₜₑₘₚ, and the processing of calculating the radiation temperature at each future time step, with the radiation temperature model M^{bldg}ₜₑₘₚ that are performed by the comfort-index parameter range determination unit 15. These pieces of processing have already been described, and the description thereof will be omitted here.

The optimization problem is solved by an optimization solver. An appropriate optimization solver is defined by the respective function forms of the temperature model M^{air}ₜₑₘₚ, the radiation temperature model M^{bldg}ₜₑₘₚ, the comfort index model M_{comfort}, and the air conditioning power model M_{power}. Metaheuristics represented by evolutionary algorithms can be used as at least a resolvable optimization solver.

The setting value calculation unit 17 solves the optimization problem in which the objective function is expressed by Expression (22) and the constraint conditions are expressed by Expressions (13) to (20) and Expressions (23) to (25), to calculate the setting values minimizing the air-conditioning power amount. The setting value calculation unit 17 solves the optimization problem to obtain a combination of the supply air temperature s^{Ts}ₜ and the supply air volume s^{Qs}ₜ regarding each time step. As a result, a combination of the supply air temperature and the supply air volume (combination of s^{Ts}_{t,n} and s^{Qs}_{t,n}) corresponding to the combination of a time step and an air conditioner (air conditioning zone) is obtained. It can be said that this combination is a plan of setting values from the present time to a predetermined future time. The setting value calculation unit 17 inputs this plan to the air conditioner control unit 20.

When the time step corresponding to the combination of the supply air temperature s^{Ts}_{t,n} and the supply air volume s^{Qs}_{t,n} is reached, the air conditioner control unit 20 transmits the supply air temperature and the supply air volume to the air conditioner corresponding to the combination, and sets the air supply temperature and the air supply air volume in the air conditioner. As a result, the setting value calculation system 1 can control each air conditioner so that the air-conditioning power amount from the present time to a predetermined future time is minimized, in consideration of the comfort.

Next, the processing flow of the first example embodiment will be described. FIG. 6 depicts a flowchart illustrating an exemplary processing flow of the first example embodiment. Note that the detailed processing by the constituent elements of the setting value calculation system 1 has already been described, and the detailed description of the processing will be omitted below.

The various setting values input from the setting value calculation system 1 or from the user through the input unit 10 are stored (step S11).

Specifically, the comfort-index parameter range setting value storage unit 11 stores the setting value validity, the setting lower limit, and the setting upper limit of each type of calculation parameter input from the user. However, in the present example embodiment, it is assumed that the attribute value of the setting value validity is invalid. In addition, regarding each of the clothing insulation and the metabolic rate, the comfort-index parameter range setting value storage unit 11 stores one value input by the user. Moreover, it is assumed that the comfort-index parameter range setting value storage unit 11 prestores the legal lower limit and legal upper limit of each type of calculation parameter. As a result, the comfort-index parameter range setting value storage unit 11 retains the table 110 exemplified in FIG. 3.

In addition, in step S11, the setting value upper-and-lower limit range storage unit 12 stores the lower limit and upper limit of the setting values per air conditioner input from the user. As a result, the setting value upper-and-lower limit range storage unit 12 retains the table 120 exemplified in FIG. 4.

Moreover, in step S11, the operation-plan setting value storage unit 13 stores the operation-plan setting value input from the user.

Next to step S11, the comfort-index parameter range determination unit 15 determines the range of possible values of each type of calculation parameter, on the basis of the table 110 retained by the comfort-index parameter range setting value storage unit 11, the table 120 retained by the setting value upper-and-lower limit range storage unit 12, and an air conditioning model (step S12). Note that when performing computation of Expressions (13) and (14), the comfort-index parameter range determination unit 15 also uses the various measured values input from the measured value acquisition unit 14 and the various predicted values input from the predicted value acquisition unit 18.

Next, the comfort index model generation unit 16 calculates the comfort index model M_{comfort} on the basis of the range of possible values of each type of calculation parameter (step S13).

Next, the setting value calculation unit 17 calculates the setting values of the one or more setting items for the one or more air conditioners to be controlled, on the basis of the various setting values input from the setting value upper-and-lower limit range storage unit 12, the operation-plan setting values input from the operation-plan setting value storage unit 13, and the various measured values input from the measured value acquisition unit 14, the various predicted values input from the predicted value acquisition unit 18, the various air conditioning models input from the air conditioning model storage unit 19, and the comfort index model input from the comfort index model generation unit 16 (step S14).

Next, on the basis of the setting values, when the time step corresponding to the setting values is reached, the air conditioner control unit 20 sets the setting values in the air conditioners corresponding to the setting values (step S15).

According to the present example embodiment, the comfort index is not limited to a specific parameter such as temperature or humidity. Then, according to the present example embodiment, the comfort index model generation unit 16 generates the comfort index model for calculating the comfort index from a plurality of calculation parameters (in the example of the present example embodiment, the temperature, the radiation temperature, the supply air volume, the relative humidity, the clothing insulation, and the metabolic rate). Therefore, a more accurate comfort index value can be obtained as compared with a case where a specific parameter such as the temperature is used as a simple comfort index value. In other words, there can be obtained a comfort index value that does not deviate from the comfort actually felt by a person. Therefore, the setting value calculation unit 17 can calculate setting values for air conditioners, with such a comfort index value.

Furthermore, in the present example embodiment, the comfort-index parameter range determination unit 15 determines the range of each calculation parameter. In the above example, the comfort-index parameter range determination unit 15 determines the respective ranges of the temperature, the radiation temperature, the supply air volume, and the relative humidity. In addition, regarding each of clothing insulation and metabolic rate, one value set by the user is used as a constant. Then, the comfort index model generation unit 16 samples the value of each calculation parameter from the determined range, and generates a comfort index model on the basis of the sampled value. Therefore, the comfort index model can be calculated with easy calculation, and the accuracy of the comfort index value that is obtained on the basis of the comfort index model can be further increased. Therefore, the comfort index value can be calculated easily and accurately, and the setting values for the air conditioners can be calculated with the comfort index value.

As described above, the comfort-index parameter range determination unit 15 determines the range of the calculation parameter, and the comfort index model generation unit 16 samples the value of each calculation parameter from the determined range to generate the comfort index model on the basis of the sampled values. As a result, the comfort index model can be calculated with easy calculation, and the accuracy of the comfort index value that is obtained on the basis of the comfort index model can be further increased. This point will be described schematically. FIG. 7 depicts a schematic graph illustrating that limitation of a parameter range makes calculation of an approximation function simple, and the accuracy of the approximated value by the approximation function is increased. Here, in order to simplify the description, there will be described, as an example, a case where the range of x is limited when the function y=f(x) is approximated. As illustrated in FIG. 7, it is considered that a case where the range of x is limited when the function y=f(x) is approximated and x within the range is sampled to calculate the approximation function y=g(x)=ax+b. In a case where an approximation function of y=f(x) over the entire range of x without limitation to x, the approximation function is a complex expression. However, it can be seen that in the case where the range of x is limited and x within the range is sampled to calculate the approximation function, the approximation function can be simplified. In the example illustrated in FIG. 7, it can be seen that the approximation function can be expressed by a linear function of x, which makes derivation of the approximation function simple, and the value of y obtained by the approximation function y=g(x)=ax+b is close to the value of y obtained by y=f(x). In the example of the present example embodiment, the comfort index model generation unit 16 calculates the comfort index model M_{comfort} for obtaining the approximated value of the absolute value of PMV, with the values sampled from the respective ranges defined for T^{air}, T^{bldg}, T^{Qs}, and C^{humid}, C^{cloth} and C^{mets} as constants. Therefore, it is easy to derive the comfort index model M_{comfort}, and the accuracy of the absolute value of PMV obtained from the comfort index model M_{comfort} is high. As a result, effects such as described above can be obtained.

Effects such as described above are similar to those in the example embodiments to be described later.

In addition, in the above described example embodiment, it is assumed that all attribute values of the setting value validity of the temperature, the relative humidity, the radiation temperature, and the airflow speed are “invalid”. In this case, regarding each of the temperature, the relative humidity, the radiation temperature, and the airflow speed, the setting upper limit and the setting lower limit are multiplied by 0. (See Expressions (1) to (8)). Therefore, the setting upper limit and the setting lower limit do not affect the results of the upper limits and the lower limits of the parameters described above. Specifically, the upper limit of the temperature is actually determined on the basis of the legal upper limit and the model upper limit (see Expression (1)), and the lower limit of the temperature is actually determined by the legal lower limit and the model lower limit (see Expression (2)). In addition, the upper limit of the radiation temperature is actually determined on the basis of the model upper limit (see Expression (3)), and the lower limit of the radiation temperature is actually determined on the basis of the model lower limit (see Expression (4)). Moreover, the upper limit of the relative humidity is actually determined on the basis of the legal upper limit (see Expression (5)), and the lower limit of the relative humidity is actually determined on the basis of the legal lower limit (see Expression (6)). Similarly, such determination is also made to the airflow speed. Therefore, regarding the temperature, the relative humidity, the radiation temperature, and the airflow speed, know-how for inputting an appropriate setting lower limit and an appropriate setting upper limit is not required. As a result, the burden of setting such an appropriate setting upper limit and an appropriate setting lower limit is reduced for the user. Disabling each setting value validity in such a manner results in reduction of the burden on the user of defining the setting lower limit and the setting upper limit. This point is similar to the point in each example embodiment to be described later.

Furthermore, in order to enable the setting value validity, the user needs to input appropriate setting lower limit and setting upper limit regarding the calculation parameter. Even in that case, the comfort-index parameter range determination unit 15 determines the range of possible values of the calculation parameter, and the comfort index model generation unit 16 samples a value of each calculation parameter from the determined range to generate a comfort index model on the basis of the sampled value. Therefore, the comfort index model can be calculated with easy calculation, and the accuracy of the comfort index value that is obtained on the basis of the comfort index model can be further increased. Furthermore, the setting values for air conditioners can be calculated with the comfort index value.

Furthermore, according to the present invention, the comfort index model generation unit 16 calculates the comfort index model M_{comfort} by supervised learning, or generates the comfort index model M_{comfort} in form of a lookup table, for example. Therefore, the comfort index model M_{comfort} can be easily obtained even if the comfort index has characteristics such as nonlinearity, nonconvexity, or a non-differentiable point, for the calculation parameter. Furthermore, the comfort index is not limited to a specific comfort index, and various comfort indices can be used. In a second example embodiment described below, there will be described a case where a comfort index different from the absolute value of PMV is used.

### Second Example Embodiment

In a second example embodiment, there will be described, as an example, a case where a setting value calculation system adopts predicted percentage of dissatisfied (PPD) as a comfort index. PPD is also referred to as predicted percentage of thermally dissatisfied people.

Similarly to the setting value calculation system 1 of the first example embodiment, the setting value calculation system of the second example embodiment can be represented by the block diagram illustrated in FIG. 2. Thus, the second example embodiment will be described with reference to FIG. 2. Note that the description of the matters similar to those in the first example embodiment will be omitted.

A comfort index model generation unit 16 calculates a comfort index model M_{comfort} on the basis of a calculated range input from a comfort-index parameter range determination unit 15. In the present example embodiment, the comfort index model M_{comfort} has a relationship with the comfort index, expressed by Expression (26) below:

[Mathematical Formula 26]

PPD(T^{air},T^{bldg},M_{airspeed}(T^{Qs}),C^{humid},C^{cloth},C^{mets})˜M_{comfort}(T^{air},T^{bldg},T^{Qs},C^{humid},C^{cloth},C^{mets}) (26)

PPD represented on the left side of Expression (26) is a function that returns a value of PPD, with the values of temperature, radiation temperature, relative humidity, airflow speed (airflow speed transformed from supply air volume), clothing insulation, and metabolic rate as input values. A known function may be used as PPD represented on the left side of Expression (26). Note that PPD is a comfort index transformable from PMV. The elements except the function PPD in Expression (26) are as described in the first example embodiment, and the description thereof will be omitted here.

Except that the comfort index is PPD, the method of calculating the comfort index model M_{comfort} is similar to the method of calculating the comfort index model M_{comfort} in the first example embodiment. That is, the comfort index model generation unit 16 derives a plurality of combinations of the value of PPD with each value of T^{air}, T^{bldg}, T^{Qs}, C^{humid}, C^{cloth}, and C^{mets}, on the basis of PPD represented on the left side of the Expression (26) and each value of T^{air}, T^{bldg}, T^{Qs}, C^{humid}, C^{cloth} and C^{mets}. At this time, the comfort index model generation unit 16 is required at least to sample each value of T^{air}, T^{bldg}, T^{Qs}, and C^{humid} from the range of possible values of each calculation parameter input from the comfort index model generation unit 16. In addition, C^{cloth} and C^{mets} are constants set by the user.

Then, for example, the comfort index model generation unit 16 is required at least to calculate, with the plurality of combinations as learning data, coefficients and a constant term in a linear regression expression or a nonlinear regression expression for acquisition of M_{comfort}. Alternatively, the comfort index model generation unit 16 may calculate the comfort index model M_{comfort} by machine learning such as a neural network.

In addition, the comfort index model generation unit 16 may generate a comfort index model M_{comfort} in form of a lookup table.

Moreover, in the present example embodiment, an operation-plan setting value storage unit 13 stores a target value of PPD input though the input unit 10. A setting value calculation unit 17 sets the target value of PPD to c^{target} in Expression (25).

The other points are similar to those in the first example embodiment.

In the second example embodiment, effects similar to those in the first example embodiment can be obtained.

Furthermore, in the second example embodiment, the left side of Expression (25) means the percentage of thermally dissatisfied people in all air conditioning zones. Thus, the target value of the comfort index (target value of PPD) can be easily set due to its interpretability.

### Third Example Embodiment

Similarly to the setting value calculation system 1 of the first example embodiment, a setting value calculation system of a third example embodiment can be represented by the block diagram illustrated in FIG. 2. Thus, the third example embodiment will described with reference to FIG. 2. Note that the description of the matters similar to those in the first example embodiment will be omitted.

The setting value calculation units 17 of the first example embodiment and the second example embodiment each solve the optimization problem for minimizing the air-conditioning power amount, with the comfort index value as the constraint condition, to calculate the setting values. In contrast, a setting value calculation unit 17 of the third example embodiment uses a comfort index value in an objective function. Specifically, the setting value calculation unit 17 of the third example embodiment uses a weighted mean value of the comfort index value in the objective function. More specifically, the setting value calculation unit 17 uses Expression (27) described below instead of Expression (22) in the first example embodiment, as the objective function in the optimization problem.

$$\begin{matrix}[ Mathematical Formula 27 ] & \\ {minimize}_{{{s}_{t , n}^{T s} ∀ n , t}_{{s}_{t , n}^{Q S} ∀ n , t}} {\sum }_{t = 1}^{T} {\sum }_{n = 1}^{N} {w}_{t , n} {c}_{t , n} & ( 27 )\end{matrix}$$

In addition, with use of Expression (27) as the objective function, in the third example embodiment, Expression (23) and Expression (25) are excluded from the constraint conditions in the first example embodiment. That is, in the third example embodiment, the setting value calculation unit 17 solves an optimization problem in which the objective function is expressed by Expression (27) described above and the constraint conditions are expressed by Expressions (13) to (20), and (24), to calculate setting values minimizing the weighted mean value of the comfort index value.

The other points are similar to those in the first example embodiment.

In the third example embodiment, it can be said that the setting value calculation unit 17 optimizes the comfort index to calculate the setting values.

In the third example embodiment, effects similar to those in the first example embodiment can be obtained.

In addition, in the third example embodiment, the objective function is the weighted mean value of the comfort index value. As a result, in the third example embodiment, there can be obtained setting values maximizing the comfort felt by a person.

Moreover, the second example embodiment may be applied to the third example embodiment. That is, PPD may be used as the comfort index.

In each example embodiment described above, the case where the comfort index is the absolute value of PMV or the case where the comfort index is PPD has been described; however, other types of comfort index may be used in the present invention. In addition, comfort-index calculation parameters are not limited to the calculation parameters indicated in the above description.

Moreover, in each example embodiment described above, the setting value calculation unit 17 solves the optimization problem to calculate the setting values. The setting value calculation unit 17, however, may calculate the setting values in a different manner.

Furthermore, in each example embodiment described above, the setting value calculation system 1 may display the setting values calculated by the setting value calculation unit 17. FIG. 8 depicts a block diagram illustrating a configuration example of a setting value calculation system that displays the setting values. The same elements as those already described are denoted by the same reference signs as those in FIG. 2, and the description thereof will be omitted.

A setting value calculation system 1 exemplified in FIG. 8 includes a display control unit 21 and a display device 22 in addition to the elements illustrated in FIG. 2. The display control unit 21 causes the display device 22 to display the setting values at each time step and in each air conditioner calculated by the setting value calculation unit 17.

The display control unit 21 is realized by, for example, a CPU of a computer, the CPU operating according to a setting value calculation program.

Even in the configuration example exemplified in FIG. 8, a value of a comfort index can be calculated easily and accurately, and setting values for the air conditioners can be calculated with the value of the comfort index. Then, the display control unit 21 causes the display device 22 to display the setting values. Therefore, the setting values calculated with the comfort index can be presented to the user.

Furthermore, in each example embodiment described above, it has been described that the setting value calculation system 1 includes the air conditioner control unit 20 and the air conditioner control unit 20 sets the setting values in each air conditioner. The setting value calculation system 1 of the present invention may not set the setting value in each air conditioner. FIG. 9 depicts a block diagram illustrating a configuration example when no setting value is set in each air conditioner. The same elements as those illustrated in FIGS. 2 and 8 are denoted by the same reference signs as those in FIGS. 2 and 8, and the description thereof will be omitted.

A setting value calculation system 1 exemplified in FIG. 9 has a configuration in which the air conditioner control unit 20 is excluded from the setting value calculation system 1 exemplified in FIG. 8. Since the setting value calculation system 1 exemplified in FIG. 9 does not include an air conditioner control unit 20 (see FIGS. 2 and 8), the setting value calculation system 1 does not have a function of setting setting values in each air conditioner. However, even in the configuration exemplified in FIG. 9, a display control unit 21 causes a display device 22 to display the setting values. Therefore, the setting values calculated with a comfort index can be presented to the user.

FIG. 10 depicts a schematic block diagram illustrating a configuration example of a computer according to the example embodiments of the present invention and the modifications of the example embodiments. A computer 1000 includes a CPU 1001, a main storage device 1002, a computer-readable recording medium 1003, a communication interface 1004, a display device 1005, and an input device 1006.

The setting value calculation system 1 according to the example embodiments of the present invention and the modifications of the example embodiments is implemented in the computer 1000. The operation of the setting value calculation system 1 is stored in the computer-readable recording medium 1003 in form of a setting value calculation program. The CPU 1001 reads the program from the recording medium 1003, and develops the program in the main storage device 1002 to execute the above described processing according to the program.

Note that the input device 1006 corresponds to the input unit 10. The display device 1005 corresponds to the display device 22 illustrated in FIG. 8 or 9. The communication interface 1004 is used when the CPU 1001 operates as the air conditioner control unit 20 and sets setting values in each air conditioner. In addition, the communication interface 1004 is also used when the CPU 1001 operates as the measured value acquisition unit 14 and acquires various measured values from an external device. Moreover, the communication interface 1004 is also used when the CPU 1001 operates as the predicted value acquisition unit 18 and acquires various predicted values from an external device.

The recording medium 1003 is a non-transitory computer-readable recording medium. In addition, the recording medium 1003 is a tangible recording medium. Examples of the recording medium 1003 include a magnetic recording medium (e.g., flexible disk, magnetic tape, and hard disk drive), a magneto-optical recording medium (e.g., a magneto-optical disk), a compact disk read only memory (CD-ROM), a CD-R, a CD-R/W, a digital versatile disk read only memory (DVD-ROM), a Blu-ray (registered trademark) disk, and a semiconductor memory. In addition, examples of the semiconductor memory include a mask read only memory (ROM), a programmable ROM (PROM), an Erasable PROM (EPROM), a flash ROM, and a random access memory (RAM).

Moreover, the setting value calculation program may be supplied to the computer by various types of transitory computer-readable recording media. Examples of these recording media include electric signals, optical signals, and electromagnetic waves. The transitory recording media are each capable of supplying the program to the computer though a wired communication channel such as an electric wire or an optical fiber, or a wireless communication channel.

Furthermore, in the setting value calculation system 1 exemplified in FIG. 2, 8, or 9, each element may be realized by separate hardware.

Next, the overview of the present invention will be described. FIG. 11 depicts a block diagram illustrating the overview of the present invention. The setting value calculation system of the present invention calculates setting values for one or more air conditioners installed in a building. The setting value calculation system of the present invention includes the comfort-index parameter range determination unit 15, the comfort index model generation unit 16, and the setting value calculation unit 17.

For one or more parameters of a plurality of parameters to be used for calculation of a comfort index, the comfort-index parameter range determination unit 15 determines the range of possible values of each of the one or more parameters.

The comfort index model generation unit 16 generates a mathematical model (e.g., comfort index model M_{comfort}) of the comfort index by approximating the comfort index on the basis of each range determined regarding one or more parameters.

The setting value calculation unit 17 calculates, with the comfort index, on the basis of the mathematical model, setting values of one or more setting items for the one or more air conditioners.

Such a configuration enables the value of the comfort index to be calculated easily and accurately, and calculation of the setting values for the air conditioners with the value of the comfort index.

The above described example embodiments of the present invention can also be described as the following supplementary notes, but are not limited thereto.

### (Supplementary Note 1)

A setting value calculation system that calculates setting values for one or more air conditioners installed in a building, the setting value calculation system including:

a comfort-index parameter range determination unit that determines, for one or more parameters of a plurality of parameters to be used for calculation of a comfort index, a range of possible values of each of the one or more parameters;

a comfort index model generation unit that approximates the comfort index, on the basis of the values within the range determined for each of the one or more parameters, to generate a mathematical model of the comfort index; and

a setting value calculation unit that calculates, with the comfort index, setting values of one or more setting items for the one or more air conditioners on the basis of the mathematical model.

### (Supplementary Note 2)

The setting value calculation system according to Supplementary note 1, further including:

an air conditioner control unit that sets the setting values in the air conditioners.

### (Supplementary Note 3)

The setting value calculation system according to Supplementary note 1 or 2, in which one of the plurality of parameters is temperature.

### (Supplementary Note 4)

The setting value calculation system according to any of Supplementary notes 1 to 3, in which one of the plurality of parameters is relative humidity.

### (Supplementary Note 5)

The setting value calculation system according to any of Supplementary notes 1 to 4, in which one of the plurality of parameters is radiation temperature.

### (Supplementary Note 6)

The setting value calculation system according to any of Supplementary notes 1 to 5, in which one of the plurality of parameters is supply air volume.

### (Supplementary Note 7)

The setting value calculation system according to any of Supplementary notes 1 to 6,

in which the comfort-index parameter range determination unit determines a range of possible values of part of the plurality of parameters, on the basis of a legal upper limit and a legal lower limit.

### (Supplementary Note 8)

The setting value calculation system according to any of Supplementary notes 1 to 7,

in which the comfort-index parameter range determination unit determines a range of possible values of part of the plurality of parameters, on the basis of an upper limit and a lower limit specified by a user.

### (Supplementary Note 9)

The setting value calculation system according to any of Supplementary notes 1 to 8,
in which the comfort-index parameter range determination unit determines a range of possible values of part of the plurality of parameters, on the basis of an upper limit and a lower limit determined with a model capable of calculating the possible values of the part of the plurality of parameters.

### (Supplementary Note 10)

The setting value calculation system according to any of Supplementary notes 1 to 9,

in which the comfort index is an absolute value of predicted mean thermal sensation vote, or predicted percentage of thermally dissatisfied people.

### (Supplementary Note 11)

The setting value calculation system according to any of Supplementary notes 1 to 10,

in which the setting value calculation unit optimizes the comfort index to calculate the setting values.

### (Supplementary Note 12)

The setting value calculation system according to any of Supplementary notes 1 to 10,

in which, with the comfort index as a constraint condition, the setting value calculation unit solves an optimization problem for minimizing an air conditioning operation cost, to calculate the setting values.

### (Supplementary Note 13)

A setting value calculation method of calculating setting values for one or more air conditioners installed in a building, the setting value calculation method including:

determining, for one or more parameters of a plurality of parameters to be used for calculation of a comfort index, a range of possible values of each of the one or more parameters;

approximating the comfort index, on the basis of the values within the range determined for each of the one or more parameters, to generate a mathematical model of the comfort index; and

calculating, with the comfort index, setting values of one or more setting items for the one or more air conditioners on the basis of the mathematical model.

### (Supplementary Note 14)

A setting value calculation program installed on a computer that calculates setting values for one or more air conditioners installed in a building, the setting value calculation program for causing the computer to execute:

comfort-index parameter range determination processing of determining, for one or more parameters of a plurality of parameters to be used for calculation of a comfort index, a range of possible values of each of the one or more parameters;

comfort-index model generation processing of approximating the comfort index, on the basis of the values within the range determined for each of the one or more parameters, to generate a mathematical model of the comfort index; and

setting value calculation processing of calculating, with the comfort index, setting value of one or more setting items for the one or more air conditioners on the basis of the mathematical model.

The invention of the present application has been described above with reference to the example embodiments; however, the invention of the present application is not limited to the example embodiment described above. Various changes that can be understood by those skilled in the art can be made to the configuration and details of the invention of the present application within the scope of the invention of the present application.

### INDUSTRIAL APPLICABILITY

The present invention is preferably applied to a setting value calculation system that calculates setting values for air conditioners.

### REFERENCE SIGNS LIST

1 Setting value calculation system
10 Input unit
11 Comfort-index parameter range setting value storage unit
12 Setting value upper-and-lower limit range storage unit
13 Operation-plan setting value storage unit
14 Measured value acquisition unit
15 Comfort-index parameter range determination unit
16 Comfort index model generation unit
17 Setting value calculation unit
18 Predicted value acquisition unit
19 Air conditioning model storage unit
20 Air conditioner control unit
21 Display control unit
22 Display device

What is claimed is:

1. A setting value calculation system that calculates setting values for one or more air conditioners installed in a building, the setting value calculation system comprising:
a comfort-index parameter range determination unit that determines, for one or more parameters of a plurality of parameters to be used for calculation of a comfort index, a range of possible values of each of the one or more parameters;
a comfort index model generation unit that approximates the comfort index, on a basis of the values within the range determined for each of the one or more parameters, to generate a mathematical model of the comfort index; and
a setting value calculation unit that calculates, with the comfort index, setting values of one or more setting items for the one or more air conditioners on a basis of the mathematical model.

2. The setting value calculation system according to claim 1, further comprising:
an air conditioner control unit that sets the setting values in the air conditioners.

3. The setting value calculation system according to claim 1,
wherein one of the plurality of parameters is temperature.

4. The setting value calculation system according to claim 1,
wherein one of the plurality of parameters is relative humidity.

5. The setting value calculation system according to claim 1,
wherein one of the plurality of parameters is radiation temperature.

6. The setting value calculation system according to claim 1,
wherein one of the plurality of parameters is supply air volume.

7. The setting value calculation system according to claim 1,
wherein the comfort-index parameter range determination unit determines a range of possible values of part of the plurality of parameters, on a basis of a legal upper limit and a legal lower limit.

8. The setting value calculation system according to claim 1,
wherein the comfort-index parameter range determination unit determines a range of possible values of part of the plurality of parameters, on a basis of an upper limit and a lower limit specified by a user.

9. The setting value calculation system according to claim 1,
wherein the comfort-index parameter range determination unit determines a range of possible values of part of the plurality of parameters, on a basis of an upper limit and a lower limit determined with a model capable of calculating the possible values of the part of the plurality of parameters.

10. The setting value calculation system according to claim 1,
wherein the comfort index is an absolute value of predicted mean thermal sensation vote, or predicted percentage of thermally dissatisfied people.

11. The setting value calculation system according to claim 1,
wherein the setting value calculation unit optimizes the comfort index to calculate the setting values.

12. The setting value calculation system according to claim 1,
wherein, with the comfort index as a constraint condition, the setting value calculation unit solves an optimization problem for minimizing an air conditioning operation cost, to calculate the setting values.

13. A setting value calculation method of calculating setting value for one or more air conditioners installed in a building, the setting value calculation method comprising:
determining, for one or more parameters of a plurality of parameters to be used for calculation of a comfort index, a range of possible values of each of the one or more parameters;
approximating the comfort index, on a basis of the values within the range determined for each of the one or more parameters, to generate a mathematical model of the comfort index; and
calculating, with the comfort index, setting values of one or more setting items for the one or more air conditioners on a basis of the mathematical model.

14. A non-transitory computer-readable recording medium in which a setting value calculation program is recorded, the setting value calculation program installed on a computer that calculates setting values for one or more air conditioners installed in a building, the setting value calculation program causing the computer to execute:
comfort-index parameter range determination processing of determining, for one or more parameters of a plurality of parameters to be used for calculation of a comfort index, a range of possible values of each of the one or more parameters;
comfort-index model generation processing of approximating the comfort index, on a basis of the values within the range determined for each of the one or more parameters, to generate a mathematical model of the comfort index; and
setting value calculation processing of calculating, with the comfort index, setting value of one or more setting items for the one or more air conditioners on a basis of the mathematical model.
